(19) United States
(12) Patent Application Publication
(10) Pub. No.: US 2002/0143806 A1
(43) Pub. Date: Oct. 3, 2002

(54) System and method for learning and classifying genre of document

(76) Inventors: Yong Bae Lee, Gongju-si (KR); Sung Hyun Myaeng, Yuseong-Gu (KR)

Correspondence Address: VENABLE, P.O. Box 34385, Washington, DC, 20043-9998, US

(21) Appl. No.: 10/060,289

(22) Filed: Feb. 1, 2002

(30) Foreign Application Priority Data
Feb. 3, 2001 (KR) KR 2001-5252

(51) Int. Cl. G06F 17/24; G06F 17/21; G06F 17/00; G06F 15/00

(52) U.S. Cl. 707/500

(57) ABSTRACT

A system and method for learning and classifying document genres is disclosed. This invention provides a system and a method for learning genres of documents, extracting and storing genre representing terms and genre classifying terms. A system for classifying document genres of the present invention includes: a genre learning block for generating genre representing terms and genre classifying terms which make it possible to classify genres of document; and a genre classifying block for classifying the genres of documents by using the genre classifying terms generated in the genre learning block.

### FIELD OF THE INVENTION

The present invention relates to a system and a method for learning and classifying genres of documents, and a computer-readable recording medium for recording a program which embodies the same method; and, more particularly, to a system and a method for learning and classifying document genres by learning genres of documents in a database or on a communication network, e.g., the Internet, and extracting and storing genre representing terms and genre classifying terms, and a computer-readable recording medium for recording a program which embodies the method.

Further, this invention discloses a system and a method for learning and classifying genres of documents, which automatically perform document classification by genres according to the actual form and type by learning the genre of documents in a database or on a communication network, e.g., the Internet, and extracting and storing the genre representing terms and the genre classifying terms, and a computer-readable recording medium for recording a program which embodies the method.

### DESCRIPTION OF RELATED ART

As there are a great deal of attempts for gathering information through the Internet due to the generalization of Internet and the types of information on the Internet become more various, the significance of classifying documents precisely comes into the limelight. Besides, even in off-line, the amount of documents is huge, so it is very hard to find desired documents.

Conventional document classifying systems employ a method classifying documents according to the contents and themes.

Classification by theme means a method classifying documents according to the points or subjects of documents, such as, society, science, culture, sports, etc.

However, as the amount of information increases, users call for a classification by genres in which documents are Is classified according to the forms and types of documents other than a classification by the contents or themes.

The classification by genres is to classify documents according to the forms and types of documents, such as, news articles, reports, theses, judicial rulings and so forth.

With hundreds and thousands of search results on the Internet, the sea of information, it is really difficult to find a document of a genre exactly desired.

### SUMMARY OF THE INVENTION

It is, therefore, an object of the present invention to provide a system and a method for classifying a genre of a document, which automatically perform document classification by genres according to the actual forms and types by learning genres of documents, and extracting and storing genre representing terms and genre classifying terms, and a computer-readable recording medium for recording a program which embodies the same method.

It is another object of the present invention to provide a system and a method for learning genres of documents according to the actual forms and types by learning genres of documents, and extracting and storing genre representing terms and genre classifying terms, and a computer-readable recording medium for recording a program which embodies the same method.

In accordance with an embodiment of the present invention, there is provided a system for classifying genres of documents, including: a genre learning block for generating genre representing terms and genre classifying terms which make it possible to classify a genre of a document; and a genre classifying block for classifying a genre of a document based on the genre classifying terms generated in the genre learning block.

In accordance with another embodiment of the present invention, there is provided a method for classifying genres of documents applied to a document genre classifying system, including the steps of: a) at a genre learning block, learning documents to generate genre representing terms and genre classifying terms to make it possible to classify a genre of document; and b) at a genre classifying block, determining and classifying the genres of documents based on the genre classifying terms generated in the genre learning block.

In accordance with further another embodiment of the present invention, there is provided a computer-readable recording medium storing a program for executing a method for classifying genres of document, the method including the steps of: a) at a genre learning block, learning documents to generate genre representing terms and genre classifying terms to make it possible to classify a genre of document; and b) at a genre classifying block, determining and classifying the genres of documents based on the genre classifying terms generated in the genre learning block.

In accordance with further another embodiment of the Is present invention, there is provided a system for learning genres of documents, including: a genre representing term extraction unit for obtaining actual contents of the document, extracting index terms, and determining and storing genre representing terms; a genre representing term storage unit for storing the genre representing terms extracted from the genre representing term extraction unit; and a genre classifying term extraction unit for extracting the genre representing terms in the genre representing term storage unit based on a control signal from the genre representing term extraction unit and determining the genre classifying terms.

In accordance with still further another embodiment of the present invention, there is provided a method for learning genres of documents applied to a document genre learning system, including the steps of: a) at a genre representing term extraction unit, extracting actual contents of a document necessary for classifying the genre of document; b) at the genre representing term extraction unit, indexing the actual contents; c) at the genre representing term extraction unit, extracting a predetermined number of index terms among terms each having high document appearing frequency in the document; d) at the genre representing term extraction unit, calculating weights of the genre representing terms by using the predetermined number of the index terms and the index terms of a content-based category; e) at the genre representing term extraction unit, storing the genre representing terms and the weights into a genre representing term storage unit; f) at the genre representing term extraction unit, determining whether there are terms representing other genres in the document, and if there are, executing the steps from the step a), and if there is none, at the genre classifying term extraction unit, calculating a determining value between the genre representing terms stored in the genre representing term storage unit and the representing terms of the other genres; and g) at the gene classifying term extraction unit, deciding genre classifying terms by applying the determining value to the genre representing terms, and storing the genre classifying terms and the determining value in a genre classifying term storage unit.

In accordance with still another embodiment of the present invention, there is provided a computer-readable recording medium storing a program for executing a method for learning genres of documents, the method including the steps of; a) at a genre representing term extraction unit, extracting actual contents of a document necessary for classifying the genre of document; b) at the genre representing term extraction unit, indexing the actual contents; c) at the genre representing term extraction unit, extracting a predetermined number of index terms among terms each having high document appearing frequency in the document; d) at the genre representing term extraction unit calculating weights of the genre representing terms by using the predetermined number of the index terms and the index terms of a content-based category; e) at the genre representing is term extraction unit, storing the genre representing terms and the weights into a genre representing term storage unit; f) at the genre representing term extraction unit, determining whether there are terms representing other genres in the document, and if there are, executing the steps from the step a), and if there is none, at the genre classifying tern extraction unit, calculating a determining value between the genre representing terms stored in the genre representing term storage unit and the representing terms of the other genres; and g) at the gene classifying term extraction unit, deciding genre classifying terms by applying the determining value to the genre representing terms, and storing the genre classifying terms and the determining value in a genre classifying term storage unit.

### BRIEF DESCRIPTION OF THE DRAWING(S)

The above and other objects and features of the present invention will become apparent from the following description of the preferred embodiments given in conjunction with the accompanying drawings, in which:

FIG. 1 is a block diagram showing a document genre classifying system in accordance with an embodiment of the present invention;

FIG. 2 is a flow chart illustrating a method for classifying genres of documents in accordance with an embodiment of the present invention;

FIG. 3 is a flow chart describing a document learning process to generate genre representing terms and genre classifying terms that make it possible to classify genres in a genre learning block of FIG. 2 in accordance with an embodiment of the present invention;

FIG. 4 is a flow chart illustrating a process of determining and classifying the genre of documents stored in a database or on a communication network such as the Internet, by using genre classifying terms in a genre classifying block of FIG. 2 in accordance with an embodiment of the present invention; and

FIG. 5 is a graph showing the document appearing frequency rate of terms of a genre in accordance with an embodiment of the present invention.

### DETAILED DESCRIPTION OF THE INVENTION

Other objects and aspects of the invention will become apparent from the following description of the embodiments with reference to the accompanying drawings, which is set forth hereinafter.

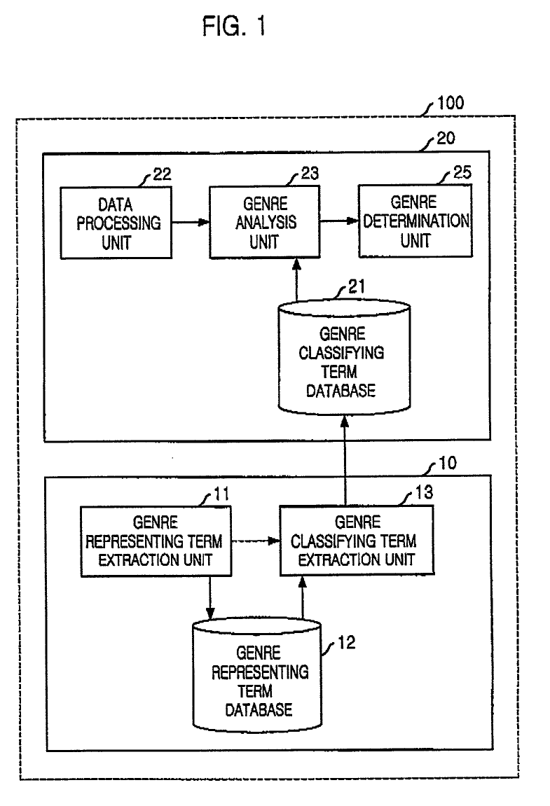

FIG. 1 is a block diagram showing a document genre classifying system in accordance with an embodiment of the present invention.

Referring to FIG. 1, a document genre classification system 100 includes: a genre learning block 10 for generating genre representing terms and genre classifying terms that make it possible to classify genres; and a genre classifying block 20 for classifying genres of documents in a database or on a communication network such as the Internet, by using the genre classifying terms generated in the genre learning block 10.

The genre learning block 10 includes a genre representing term extraction unit 11, a genre representing term database 12 and genre classifying term extraction unit 13. The genre representing term extraction unit 11 extracts index terms by obtaining actual contents, determines genre representing terms and stores them in a genre representing term database 12. The genre representing term database 12 receives and stores the genre representing terms extracted from the genre representing term extraction unit 11. The genre classifying term extraction unit 13 receives a control signal from the genre representing term extraction unit 11, extracts genre representing terms in the genre representing term database 12, and determines genre classifying terms.

The genre classifying block 20 includes a genre classifying term database 21, a document processing unit 22, a genre analysis unit 23 and a genre determination unit 25. The genre classifying term database 21 stores genre classifying terms extracted in the genre classifying term extraction unit 13. The document processing unit 22 extracts index terms by obtaining actual contents of documents in a database or on a communication network such as the Internet. The genre analysis unit 23 analyzes genre characteristics of a document by using the index terms of the document processing unit 22, genre classifying terms of the genre classifying term database 21. The genre determination unit 25 assigns genre with the highest similarity to a document of the genre characteristics analyzed in the genre analysis unit 23.

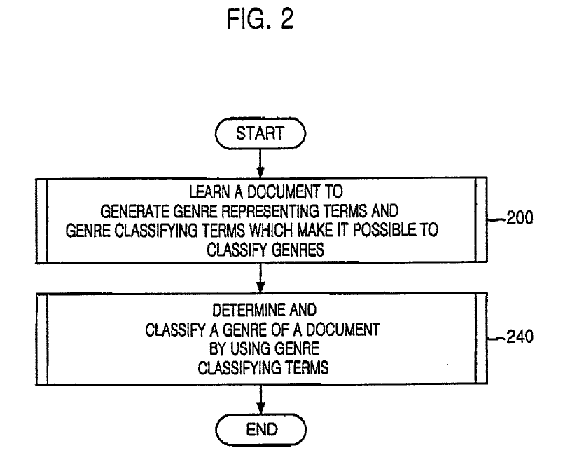

With reference to FIGS. 2 to 4, the method of classifying document genres of the present invention will be described in detail.

FIG. 2 is a flow chart illustrating a method for classifying document genres in accordance with an embodiment of the present invention.

First of all, at step 200, the genre learning block 10 learns a document to generate representing terms and genre classifying terms that make it possible to classify genres, and at step 240, the genre classifying block 20 determines and classifies a genre of a document stored in a database or on a communication network such as the Internet by using genre classifying terms

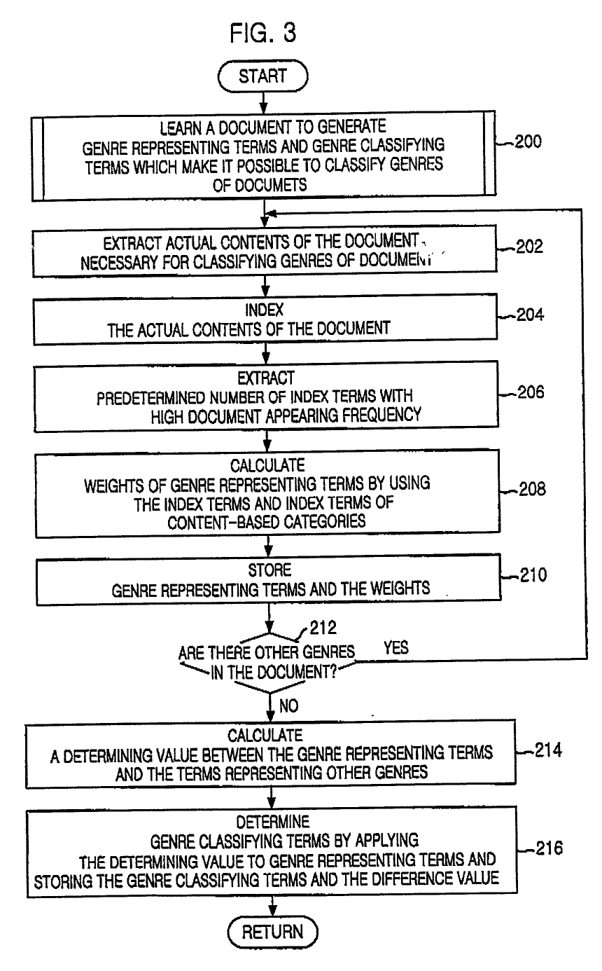

FIG. 3 is a flow chart describing a document learning process, step 200, to generate genre representing terms and genre classifying terms that make it possible to classify genres in a genre learning block of FIG. 2 in accordance with an embodiment of the present invention.

First of all, at step 202, the genre representing term extraction unit 11 extracts actual contents of a document to classify the genres of documents stored in a database or on a communication network such as the Internet, and at step 204, indexes the actual contents extracted above.

‘Indexing scope’ stands for a group of documents obtained by dividing a genre by the number of ‘all documents of a genre’ and ‘content-based categories of a genre.’ The ‘all documents of a genre’ stands for the number of the entire documents that belong to a certain genre, while the ‘content-based categories of a genre’ means the number of categories obtained by dividing all the documents of a single genre by contents and themes. For instance, if the total number of documents in a newspaper genre is 600 and the number of documents of the content-based categories of the newspaper genre is 200 in the political category, 150 in the economic category, 150 in the category of society and 100 in the culture category, at step 204, the procedure of indexing is performed on the five document groups, i.e., all the documents of the newspaper genre and the content-based categories of the newspaper genre: politics, economy, society and culture.

Also, at step 206, the genre representing term extraction unit 11 extracts a predetermined number of index terms among the terms with high document appearing frequency. Here, the document appearing frequency means the number of documents in which a certain term appear. For example, if the term ‘article’ is shown in 300 documents in total documents of the newspaper genre, the document appearing frequency of the term ‘article’, becomes 300. The predetermined number of index terms is determined by the number of learning documents of a genre, the average length of documents and the number of index terms.

At step 208, the genre representing term extraction unit 11 calculates a weight of a genre representing term by using the predetermined number of the index terms and the index terms of a content-based category, which are extracted above.

If a frequently appearing term of a certain genre appears preponderantly in an arbitrary category of the genre, it cannot be regarded as a genre representing term of the genre. In other terms, a weight of a genre representing term is calculated by using the index terms of all the documents of a genre and the index terms of a content-based category of a genre, because a term representing a genre is highly likely to appear in all content-based categories of a genre indiscriminately for that genre. At this moment, the weight is calculated not with the number of document appearing frequencies but with the document appearing frequency rate. If a weight is calculated with the number of document appearing frequencies, the weight of the category having many documents may become relatively larger than that of the category having few documents. So, based on the weight calculated with the number of frequencies, it's hard to figure out if an index term is appearing in the all categories of a genre indiscriminately.

Based on a weight calculated with index terms of total documents of a genre and index terms of content-based categories, information representing a genre can be calculated by the following equation (1).

$${R\_Val}_{m} ( {t}_{k} ) = ( 1 - \sqrt{\frac{{\sum }_{i = 1}^{{n}_{c}} {( {DFR}_{m} ( {t}_{k} ) - {DFR}_{m} ( {t}_{k}^{i} ) )}^{2}}{{n}_{c}}} ) \qquad Eg . ( 1 )$$

where tₖ is an index term k,

DFRₘ(tₖ) is a document appearing frequency rate of an index term k that appears highly frequently in all the documents of the genre m,

DFRₘ(t¹ₖ) is a document appearing frequency rate of a term k in a content-based category i of the genre m, and

n_{c} is the number of content-based categories of the genre m.

Here, the rate of document appearing frequency for a certain term means the ratio of document appearing frequency of the term to the number of entire documents of indexed document groups. For instance, if a term ‘incident’ appears .in 50 documents among 200 documents of a newspaper genre, the rate of document appearing frequency of the term ‘incident’ in the newspaper genre becomes 0.25. The larger the weight of a genre representing term obtained by using n number of index terms of all documents of a genre and the index terms of content-based categories of the genre becomes, the more likely the term becomes to be a genre representing term. On the contrary, the smaller the weight gets, the less likely the term becomes to be a genre representing term. Accordingly, the R_Valₘ(tₖ) which is a value indicating that a term k represents a genre m, can be expressed as:

$$( 1 - \sqrt{\frac{{\sum }_{i = 1}^{{n}_{c}} {( {DFR}_{m} ( {t}_{k} ) - {DFR}_{m} ( {t}_{k}^{i} ) )}^{2}}{{n}_{c}}} ) .$$

For example, if the document appearing frequency rate of a term ‘incident’ in a newspaper genre is 0.25, and if it is 0.15 in the category of politics; 0.18 in the category of economy; 0.42 in the category of society; and 0.30 in the category of culture of the genre, the value of the term ‘incident’ representing the newspaper genre becomes:

$$1 - \sqrt{\frac{{0.1}^{2} + {0.07}^{2} + {0.17}^{2} + {0.05}^{2}}{4}} = 0.8924 .$$

At step 210, the genre representing term extraction unit 11 determines genre representing terms based on the weights calculated as above, and stores them in the genre representing term database 12. Once the R_Valₘ(tₖ) of each of index terms is calculated, it should be determined whether a term k with a R_Valₘ(tₖ) value could be a genre representing term. As the R_Valₘ(tₖ) value varies according to DFRₘ(tₖ), genre representing terms are determined with weight values of final genre representing terms by using the following equation (2).

WR_{—}Valₘ(tₖ)=R_{—}Valₘ(tₖ)×DFRₘ(tₖ) Eq. (2)

In the equation (2), the determination value WR_Valₘ(tₖ) of a genre representing term is obtained by multiplying a genre representing level R_Valₘ(tₖ) of a term by a document appearing frequency rate DFRₘ(tₖ) of total documents of a genre. Here, only a term whose WR_{—Val}ₘ(tₖ) value is larger than a predetermined standard value p is extracted and added to a group of genre representing terms.

At step 212, the genre representing term extraction unit 11 also determines whether there are another genres in the documents.

If the result of the above step 212 shows the existence of another genre, the genre representing term extraction unit 11 repeats the logic flow from the step 202 where necessary actual contents are extracted to classify the genres of documents in a database or on a communication network such as the Internet.

If the result of the above step 212 does not show any existence of other genres, at step 214, the genre classifying term extraction unit 13 takes over the control from the genre representing term extraction unit 11 calculates determining values between the genre representing terms stored in the genre representing term database 12 and the terms representing of other genres. Terms that appear in diverse genres evenly can hardly be regarded as one representing a particular genre out of many genres. Therefore, to give a value of difference to terms with high appearing frequency in a certain genre, a genre determining value of the terms in a group of representing terms are obtained by using the following equation (3). Here, terms with large determining value in a particular genre should be regarded as those representing the genre.

$${D\_Val}_{m} ( {t}_{k} ) = \sqrt{\frac{{\sum }_{i = 1}^{{n}_{g}} {( {WR\_Val}_{m} ( {t}_{k} ) - {WR\_Val}_{i} ( {t}_{k} ) )}^{2}}{{n}_{g}}} \qquad Eq . ( 3 )$$

where, n_{g} is a number of genres in total learning documents.

Subsequently, at step 216, the genre classifying term extraction unit 13 selects genre classifying terms by applying the calculated determining value to the genre representing term. and stores the genre classifying terms and the determining value into the genre classifying term database 21.

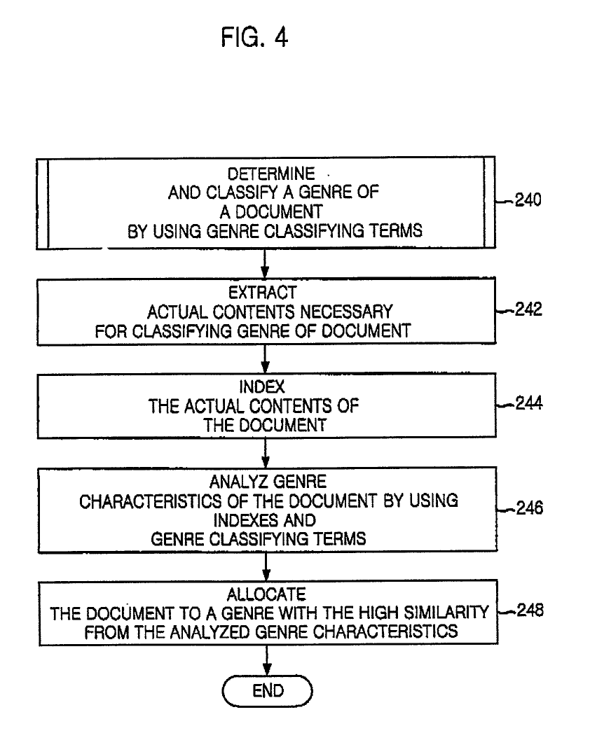

FIG. 4 is a flow chart illustrating the step 240 of determining and classifying the genres of documents stored in a database or on a communication network such as the Internet, by using genre classifying terms of each genre in a genre classifying block of FIG. 2 in accordance with an embodiment of the present invention.

First of all, at step 242, the document processing unit 22 extracts actual contents of documents necessary for classifying the genre of documents stored in a database or on a communication network such as the Internet, and at step 244, Is it indexes actual contents of the documents.

Then, at step 246, the genre analysis unit 23 acquires genre classifying terms from the genre classifying term database 21, and analyzes genre characteristics of the documents. In short, it is calculated what genre characteristics the index terms of the actual documents are distributed with. The genre characteristics are calculated with a group of genre classifying terms extracted at the learning step. To determine what kind of genre characteristics are included in a document, the value of similarity of a document and a particular genre using a distribution characteristic of a term is obtained from the following equation (4).

$${S\_Val}_{m} ( {D}_{c} ) = {\sum }_{k = 1}^{n} {D\_Val}_{m} ( {t}_{k} ) \qquad Eq . ( 4 )$$

where, D_{c} is an actual document inputted currently,

n is the number of total index terms of D_{c},

$${D\_Val}_{m} ( {t}_{k} ) = \vert \begin{matrix} 0 & when {t}_{k} ∉ {R}_{m} ( {R}_{m} being a classifying word group of a genre m ) \\ other . & \end{matrix}$$

The similarity value S_Valₘ(D_{c}) of a document to a genre m can be expressed as a sum of a determining value of genre classifying terms of index terms inputted currently.

Subsequently, at step 248, a genre determination unit 25 allocates each of the documents to a genre with the highest similarity value from the analyzed genre characteristics of the documents.

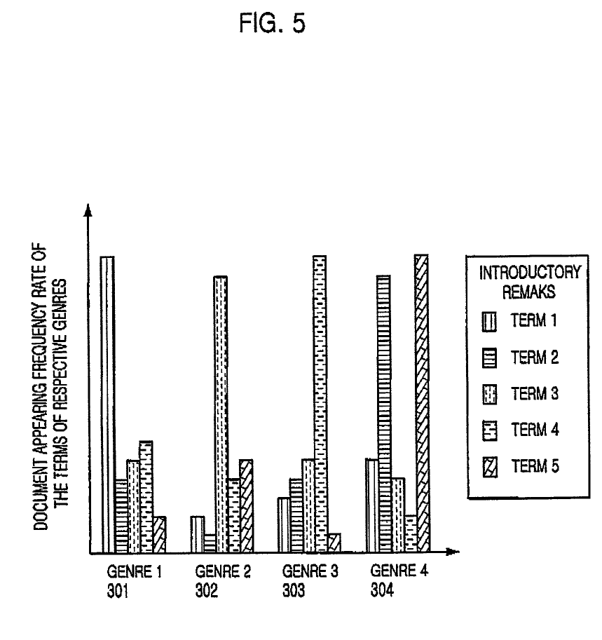

FIG. 5 is a graph showing the document appearing frequency rate of the terms of a genre in accordance with an embodiment of the present invention. The drawing shows the document appearing frequency rate of five terms extracted from a group of terms representing each of four particular genres.

A term having a higher rate of document appearing frequency in genre 301 than in other genres, the term 1 shows the largest difference than other terms 2, 3 and 4 in genre 1301. In genre 2 302, a term 3 and in genre 3 303, a term 4 show largest differences. Also, in genre 4 304, the terms 2 and 5 show larger differences than any other terms.

The method of the present invention described above can be embodied in a program and stored in a computer-readable recording medium such as CD ROMs, RAMs, ROMs, floppy disks, hard disks, optical-magnetic disks, etc.

The present invention described above can classify documents into a genre a user wants, and it can be used as a result module of a search engine operating in both on-line and off-line.

Also, this invention can reduce time and cost taken for searching documents remarkably by providing documents of a proper genre according to the users.

While the present invention has been described with respect to certain preferred embodiments, it will be apparent to those skilled in the art that various changes and modifications may be made without departing from the scope of the invention as defined in the following claims.

What is claimed is:

1. A system for classifying genres of documents, comprising:
a genre learning means for generating genre representing terms and genre classifying terms which make it possible to classify a genre of a document; and
a genre classifying means for classifying a genre of a document based on the genre classifying terms generated in the genre learning means.

2. The system as recited in claim 1, wherein the genre learning means includes:
a genre representing term extraction means for obtaining actual contents of the document, extracting index terms, and determining and storing genre representing terms;
a genre representing term storage means for storing the genre representing terms extracted from the genre representing term extraction means; and
a genre classifying term extraction means for extracting the genre representing terms in the genre representing term storage means based on a control signal from the genre representing term extraction means and determining the genre classifying terms.

3. The system as recited in claim 1, wherein the genre classifying means includes;
a document processing means for obtaining actual contents of documents and extracting index terms;
a genre classifying term storage means for storing the genre classifying terms extracted from the genre classifying term extraction means;
a genre analysis means for analyzing genre characteristics of the document by using index terms extracted in the document processing means, the genre classifying terms of the genre classifying term storage means; and
a genre determination means for classifying the document as a genre of which genre characteristic is closely similar to the genre characteristics analyzed in the genre analysis means.

4. A method for classifying genres of documents applied to a document genre classifying system, comprising the steps of:
a) at a genre learning means, learning documents to generate genre representing terms and genre classifying terms to make it possible to classify a genre of document; and
b) at a genre classifying means, determining and classifying the genres of documents based on the genre classifying terms generated in the genre learning means.

5. The method as recited in claim 4, wherein the step a) includes the steps of:
a1) at a genre representing term extraction means, extracting actual contents of a document necessary for classifying the genre of document;
a2) at the genre representing term extraction means, indexing the actual contents;
a3) at the genre representing term extraction means, extracting a predetermined number of index terms among terms each having high document appearing frequency in the document;
a4) at the genre representing term extraction means, calculating weights of the genre representing terms by using the predetermined number of the index terms and the index terms of a content-based category;
a5) at the genre representing term extraction means, storing the genre representing terms and the weights into a genre representing term storage means;
a6) at the genre representing term extraction means, is determining whether there are terms representing other genres in the document, and if there are, executing the steps from the step a1), and if there is none, at the genre classifying term extraction means, calculating a determining value between the genre representing terms stored in the genre representing term storage means and the representing terms of the other genres; and
a7) at the gene classifying term extraction means, deciding genre classifying terms by applying the determining value to the genre representing terms, and storing the genre classifying terms and the determining value in a genre classifying term storage means.

6. The method as recited in claim 5, wherein in the step a4), the genre representing terms are calculated based on the weight calculated with the index terms in all the documents of the genre and the index terms in all the documents of a content-based category, which can be expressed by an equation as:
$${R\_Val}_{m} ( {t}_{k} ) = ( 1 - \sqrt{\frac{{\sum }_{i = 1}^{{n}_{c}} {( {DFR}_{m} ( {t}_{k} ) - {DFR}_{m} ( {t}_{k}^{i} ) )}^{2}}{{n}_{c}}} )$$
where, tₖ is an index term k,
DFRₘ(tₖ) is a document appearing frequency rate of the index term k that appears highly frequently in all the documents of the genre m,
DFRₘ(tⁱₖ) is a document appearing frequency rate of a term k in a content-based category i of the genre m, and
n_{c} is a number of content-based categories of the genre m.

7. The method as recited in claim 6, wherein in the step a5), a process of determining the genre representing terms is performed based on the weights of the genre representing terms, which can be expressed by an equation as:
WR_{—}Valₘ(tₖ)=R_{—}Valₘ(tₖ)×DFRₘ(tₖ).

8. The method as recited in claim 9, wherein in the step a6), the genre determining value for genre representing terms is obtained from the weights of the genre representing terms and the weights of the genre representing terms of other genres, which can be expressed by an equation as:
$${D\_Val}_{m} ( {t}_{k} ) = \sqrt{\frac{{\sum }_{i = 1}^{{n}_{g}} {( {WR\_Val}_{m} ( {t}_{k} ) - {WR\_Val}_{i} ( {t}_{k} ) )}^{2}}{{n}_{g}}}$$
where, n_{g} is a number of genres in total learning documents.

9. The method as recited in claim 4, wherein the step b) includes the steps of:
b1) at the document processing means, extracting the actual contents of documents necessary for classifying the genres of documents stored in a storage means or on a Ads. communication network such as the Internet;
b2) at the document processing means, indexing the actual contents of documents;
b3) at a genre analysis means, receiving index terms from the document processing means obtaining genre classifying terms from the genre classifying term storage means, and analyzing the genre characteristics of the document; and
b4) at a genre determination means, allocating the document to a genre with the highest similarity from the genre characteristics of the document analyzed in the genre analysis means.

10. The method as recited in claim 9, wherein in the step b3), the similarity of the document to a particular genre, which is obtained from a distribution characteristic of a term, is calculated by an equation as:
$${S\_Val}_{m} ( {D}_{c} ) = {\sum }_{k = 1}^{n} {D\_Val}_{m} ( {t}_{k} )$$
where, D_{c} is an actual document inputted currently,
n is a number of total index terms of D_{c},
$${D\_Val}_{m} ( {t}_{k} ) = \vert \begin{matrix} 0 & when {t}_{k} ∉ {R}_{m} ( {R}_{m} being a classifying word group of a genre m ) \\ other . & \end{matrix} .$$

11. A computer-readable recording medium storing a program for executing a method for classifying genres of document, the method comprising the steps of:
a) at a genre learning means, learning documents to generate genre representing terms and genre classifying terms to make it possible to classify a genre of document; and
b) at a genre classifying means, determining and classifying the genres of documents based on the genre classifying terms generated in the genre learning means.

12. A system for learning genres of documents, comprising:
a genre representing term extraction means for obtaining actual contents of the document, extracting index terms, and detraining and storing genre representing terms;
a genre representing term storage means for storing the genre representing terms extracted from the genre representing term extraction means; and
a genre classifying term extraction means for extracting the genre representing term. in the genre representing term storage means based on a control signal from the genre representing term extraction means and determining the genre classifying terms.

13. A method for learning genres of documents applied to a document genre learning system, comprising the steps of:
a) at a genre representing term extraction means, extracting actual contents of a document necessary for classifying the genre of document;
b) at the genre representing term extraction means, indexing the actual contents;
c) at the genre representing term extraction means, extracting a predetermined number of index terms among terms each having high document appearing frequency in the document;
d) at the genre representing term extraction means, calculating weights of the genre representing terms by using the predetermined number of the index terms and the index terms of a content-based category;
e) at the genre representing term extraction means, storing the genre representing terms and the weights into a genre representing term storage means;
f) at the genre representing term extraction means, determining whether there are terms representing other genres in the document, and if there are, executing the steps from the step a), and if there is none, at the genre classifying term extraction means, calculating a determining value between the genre representing terms stored in the genre representing term storage means and the representing terms of the other genres; and
g) at the gene classifying term extraction means, deciding genre classifying terms by applying the determining value to the genre representing terms, and storing the genre classifying terms and the determining value in a genre classifying term storage means.

14. A computer-readable recording medium storing a program for executing a method for learning genres of documents, the method comprising the steps of:
a) at a genre representing term extraction means, extracting actual contents of a document necessary for classifying the genre of document;
b) at the genre representing term extraction means, indexing the actual contents;
c) at the genre representing term extraction means, extracting a predetermined number of index terms among terms each having high document appearing frequency in the document;
d) at the genre representing term extraction means, calculating weights of the genre representing terms by using the predetermined number of the index terms and the index terms of a content-based category;
e) at the genre representing term extraction means, storing the genre representing terms and the weights into a genre representing term storage means;
f) at the genre representing term extraction means, determining whether there are terms representing other genres in the document, and if there are, executing the steps from the step a), and if there is none, at the genre classifying term extraction means, calculating a determining value between the genre representing terms stored in the genre representing term storage means and the representing terms of the other genres; and
g) at the gene classifying term extraction means, deciding genre classifying terms by applying the determining value to the genre representing terms, and storing the genre classifying terms and the determining value in a genre classifying term storage means.
